(19) United States
(12) Patent Application Publication
(10) Pub. No.: US 2003/0108212 A1
(43) Pub. Date: Jun. 12, 2003

(54) Safety device for vehicles using multi-channel audio system

(76) Inventor: Seung Kook Yun, Ansan-city (KR)

Correspondence Address: Pennie & Edmonds, LLP, 3300 Hillview Avenue, Palo Alto, CA, 94304, US

(21) Appl. No.: 10/241,425

(22) Filed: Sep. 10, 2002

(30) Foreign Application Priority Data
Dec. 11, 2001 (KR) 2001-78229

(51) Int. Cl. H04B 1/00; H04R 1/02; B60Q 1/00

(52) U.S. Cl. 381/86; 340/435; 340/436; 381/389

(57) ABSTRACT

The present invention relates to a safety device for a vehicle using a multi-channel audio system. The safety device of the present invention comprises a plurality of speakers, a display unit and an audio circuit. It further comprises a plurality of sound wave sensors mounted on front and rear parts and left and right sides of the vehicle, a plurality of A/D converters for converting analog signals of the reflected sound waves from the sound wave sensors to digital signals, and a control means for converting the information on the location of obstacles to speaker output signals if the obstacle is in the danger area such that sounds are generated by the speakers. Information on the location of the obstacle also may be displayed on the display unit.

### FIELD OF THE INVENTION

The present invention relates to a safety device for a vehicle using a multi-channel audio system, and in particular to a safety device for an automobile wherein an aural or a visual warning message is generated by sensing sound waves and using the multi-channel audio system installed in the automobile.

### BACKGROUND OF THE INVENTION

Multiple channel audio systems, as in theaters, are now commonly installed in homes or in demonstration rooms of companies. In the case of the typical household audio system, it has at least five speakers as shown in FIG. 1. For example, three speakers are disposed in front of a listener and the other two speakers are disposed behind the listener. Each of the speakers operates independently and an amplifier synthesizes the movement of sounds from all speakers. Due to the five speakers surrounding the listener, the listener feels as if he were in a movie or music theater.

Such home theater systems have influenced audio systems for automobiles, and thus car audio systems tend to adopt the multi-channel system. Many car audio system products also have liquid crystal display(LCD) devices and five-channel systems. There have been no conventional automobiles, however, which have safety devices adopting the multi-channel audio systems.

### SUMMARY OF THE INVENTION

The invention provides a safety device for a vehicle in which a plurality of sound wave sensors are preferably mounted on front and rear parts and left and right sides of the vehicle. The sensors detect objects around the vehicle and generate output signals that are sent to a control means. The control means generates a warning message by using the multi-channel audio system mounted in the vehicle, thereby warning the driver of external obstacles and their location.

A preferred embodiment of the present invention comprises a plurality of speakers, a display unit, an audio circuit, and a plurality of sound wave sensors mounted on front and rear parts and left and right sides of the vehicle. Each sound wave sensor includes a sound wave generator for generating sound waves towards objects and a receiver for receiving sound waves reflected from the objects. A plurality of A/D converters convert the analog signals of the reflected sound waves, which are output from the sound wave sensors, to digital signals. A control means measures the digital signals from the A/D converters to recognize the existence of an obstacle and its location within a danger area around the vehicle. If the obstacle is in the danger area, the control means simultaneously changes the information on location of the obstacle to multi-channel speaker output information such that warning sounds, which differ depending on the location of the obstacle, are generated by the speakers via the audio circuit. The control means also preferably converts the information on the location of the obstacle to display information such that the location of the obstacle is displayed on the display unit via the audio circuit.

Therefore, according to the present invention, by using the multi-channel audio system that has already been mounted in the vehicle, a driver of a vehicle can exactly recognize the presence of dangerous obstacles and the location thereof visually and aurally while driving, and thus safety may be improved.

In an alternative embodiment of the invention, a plurality of exterior proximity sensors are disposed on the vehicle configured to sense obstacles adjacent the vehicle. Preferably, the sensors are mounted on front and rear parts of the vehicle and on left and right sides of the vehicle. A plurality of audio speakers are disposed around the vehicle interior. A controller communicates with the sensors and speakers. The controller receives signals from the sensors indicative of at least obstacle locations and generates signals output to the speakers to cause the speakers to emit sounds representative of a sensed obstacle and its location. Preferably, the controller generates signals such that sounds are emitted from the speakers positionally corresponding to the obstacle location. In addition, a plurality of A/D converters may be disposed between each sensor and the controller.

In a further preferred embodiment, the speakers form a part of a multi-channel audio system. The system additionally comprises an audio circuit disposed between the speakers and said controller to generate sound signals for the speakers. The multi-channel audio system may further comprise a display driven by the audio circuit. In this case, the controller generates signals for displaying a visual indicator of the obstacle location on the display.

### BRIEF DESCRIPTION OF THE DRAWINGS

The accompanying drawings, which are included to provide a further understanding of the invention and are incorporated in and constitute a part of this specification, illustrate an embodiment of the invention and together with the description serve to explain the principles of the invention, wherein:

FIG. 1 is a schematic view showing a conventional home theater system;

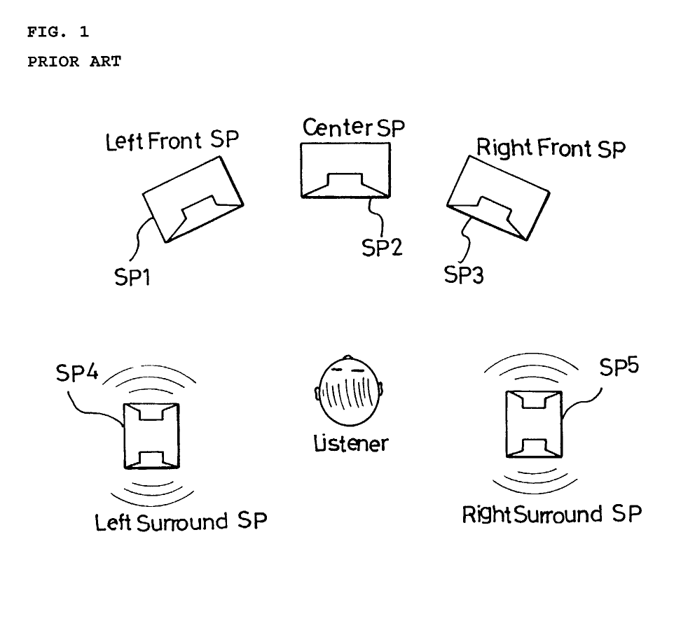

FIG. 2 is a schematic view showing a safety device according to the present invention as installed in a vehicle;

FIG. 3 is a block diagram of a safety device for a vehicle according to the present invention;

FIG. 4 is a flow chart of the operation of the safety device according to the present invention; and

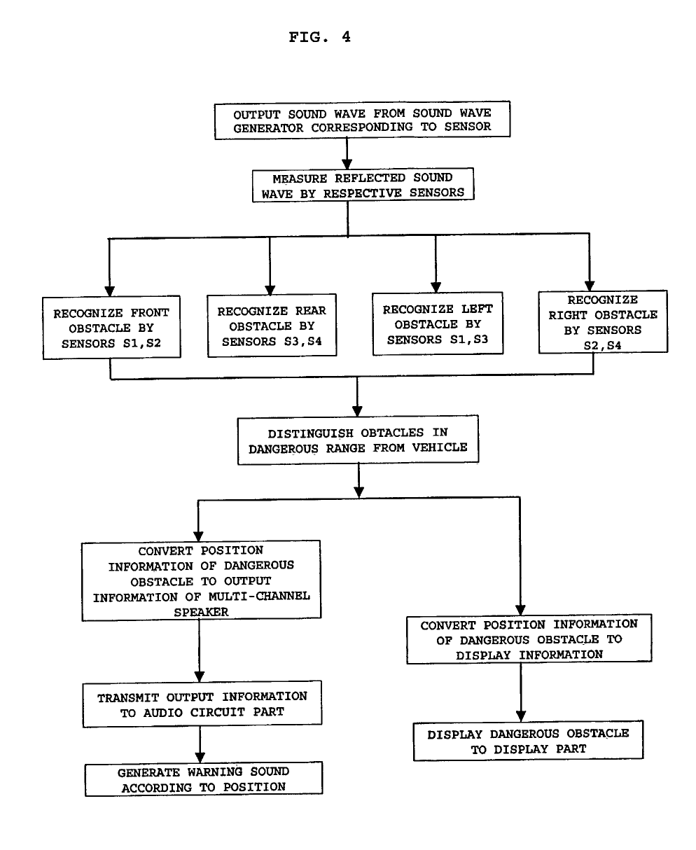

FIGS. 5a and 5b are views showing the operation of sound wave sensors according to the present invention.

### DETAILED DESCRIPTION OF THE PREFERRED EMBODIMENTS

Reference will now be made in detail to preferred embodiments of the present invention in conjunction with accompanying drawings.

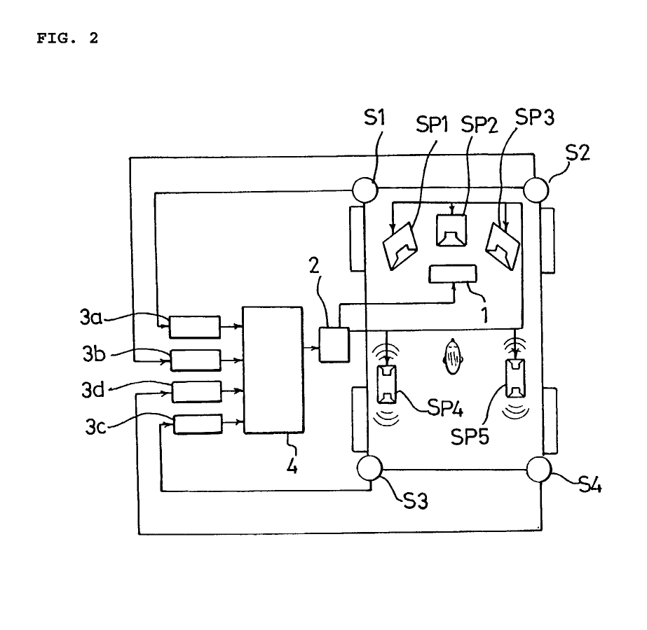

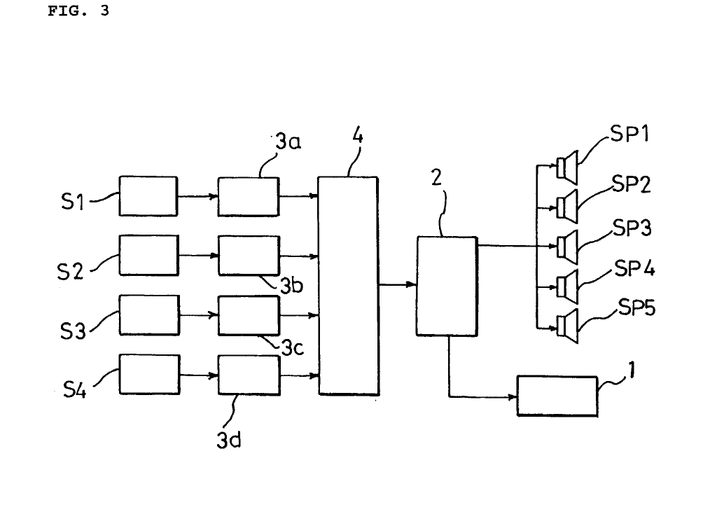

Referring first to FIGS. 2 and 3, a safety device for a vehicle using a multi-channel audio system according to a preferred embodiment of the present invention comprises a plurality of speakers SP1 to SP5, a display unit 1 and an audio circuit 2. A plurality of sound wave sensors S1 to S4 are preferably mounted on front and rear parts and left and right sides of the vehicle, each of which includes a sound wave generator for generating sound waves towards objects and a receiver for receiving sound waves reflected from the objects. A plurality of A/D converters 3a to 3n convert analog signals of the reflected sound waves, which are output from the sound wave sensors S1-S4, to digital signals.

Control means 4 includes a processor, memory and other appropriate hardware and software as may be selected by a person of ordinary skill in the art to execute control functions as described herein. For example, control means 4 is programmed to monitor the digital signals from the A/D converters 3a-3n to recognize the existence of an obstacle and its location within a danger area around the vehicle. If an obstacle is in the danger area, control means 4 outputs a signal representative of the location of the obstacle such that warning sounds, which differ depending on the location of the obstacle, are generated by the speakers SP1-SP5 via the audio circuit 2. Control means 4 also converts information on the location of the obstacle to display information such that the location of the obstacle is displayed on the display unit 1 via the audio circuit 2.

Now, the operation and effect of the safety device for an automobile according to the present invention will be described in more detail.

The safety device of the present invention uses the multi-channel audio system, which has already been mounted in the vehicle, and adopts the sound wave sensors S1-S4 to warn the driver of danger due to external obstacles or other vehicles while driving. The sound wave generators with sensors S1-S4 generate sound waves of predetermined frequencies and the receivers receive sound waves of all frequency ranges. The frequencies of the sound waves emitted from the sound wave sensors S1-S4 are independent to be distinguishable from one another. These four sound wave sensors S1-S4 form coordinates to detect the existence and the location of an obstacle in the front and rear parts and the right and left sides of the vehicle. If more than four sound wave sensors are installed in the vehicle, the detection of an obstacle may be done with more accuracy.

In addition, although optical sensors can detect the existence of obstacles, they cannot actually measure the distance between the obstacle and the vehicle since the distance is too close. Therefore, the detection of obstacles can preferably be carried out by the sound wave sensors, and in this regard, speed guns of the traffic police may be used as the sound wave sensors in the present invention.

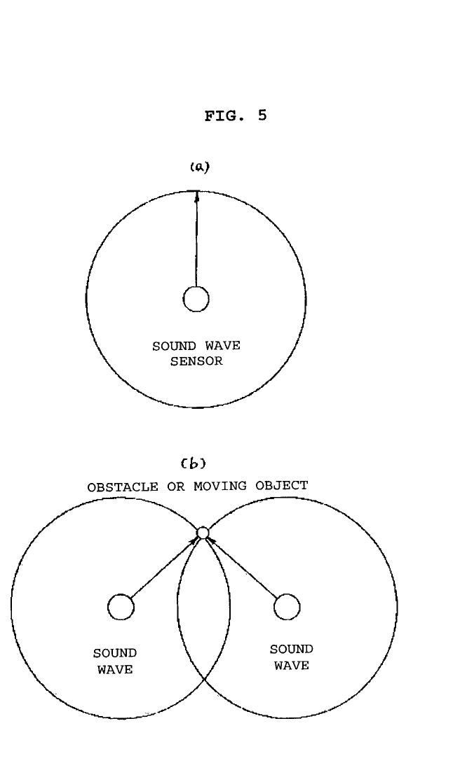

As in FIG. 5a, one sound wave sensor of the four sound wave sensors S1-S4 detects a distance between the sensor and the obstacle. FIG. 5b shows the recognition of the location of the obstacle by using two sensors of the four sound wave sensors S1-S4, wherein the opposite intersection point of the sound waves may be ignored since it is not measurable due to the structure of the vehicle.

The reflected sound waves from the objects, which are received by the sound wave sensors S1-S4, are analog signals which cannot be directly recognized by the control means 4. Accordingly, the analog signals are converted into digital signals by a plurality of A/D converters 3a-3n.

The control means 4 measures the digital signals input from the A/D converters 3a-3n to recognize the existence of an obstacle and its location within danger areas at the front and rear parts and the right and left sides of the vehicle. If the obstacle is recognized as being in the danger area, control means 4 changes the information on location of the obstacle to a multi-channel speaker output information. Warning sounds, which differ depending on the location of the obstacle, are generated by the speakers SP1-SP5 via the audio circuit 2. Simultaneously with generating the warning sounds, the control means 4 converts the information on the location of the obstacle to display information, and displays the location of the obstacle on the display unit 1 via the audio circuit 2.

The control means 4 analyzes the reflectivity of the sound waves emitted from the respective positions and the time difference thereof to form the coordinates on a plane. Then, the information on the location of the obstacle identified by the coordinates is converted into output information for the multi-channel speakers and the display information to be respectively output by the speakers SP1-SP5 and the display unit 1 via the audio circuit 2. For example, if the existence of another vehicle or an obstacle is detected in the vicinity of the left rear part of the automobile, the speaker mounted on the left rear part mainly generates a sound signal, and the left front speaker generates a weak warning sound signal. Simultaneously, a message that the obstacle appears in the left rear part is displayed on the display unit 1. Thus, the driver can recognize the existence and the location of the obstacle visually and aurally.

Further, according to the safety device of the present invention, as the driver can be informed and warned either by the warning sound or the display information, it becomes possible for the driver to precisely recognize an obstacle and its position only by the warning sound generated by the five speakers SP1-SP5 even though the driver cannot see the obstacle. Thus, a driver may aurally and visually recognize the precise positions of obstacles or other vehicles in dangerous areas by the warning sound and/or by warning characters or graphics, using a multi-channel audio system and sound wave sensors.

It will be apparent to those skilled in the art that various modifications and variations can be made to the device of the present invention without departing from the spirit and scope of the invention. The present invention covers the modifications and variations of this invention provided they come within the scope of the appended claims and their equivalents.

What is claimed is:

1. A safety device for a vehicle, comprising:
a multi-channel audio system including a plurality of speakers, a display unit and an audio circuit;
a plurality of sound wave sensors mounted on front and rear parts and left and right sides of the vehicle, each of which includes a sound wave generator for generating sound waves directed towards objects and a receiver for receiving sound waves reflected from the objects;
a plurality of A/D converters for converting analog signals of the reflected sound waves which are output from the sound wave sensors to digital signals; and
control means receiving the digital signals from the A/D converters to determine the presence of an obstacle and its location within a danger area around the vehicle, said control means providing output signals indicative of such obstacles and their location to the multi-channel audio system to generate warning sounds which differ depending on the location of the obstacle and to display information regarding the location of the obstacle on the display unit.

2. A safety device for a vehicle, comprising:
a plurality of exterior proximity sensors disposed on the vehicle configured to sense obstacles;
a plurality of audio speakers disposed around the vehicle interior;
a controller communicating with said sensors and speakers, said controller receiving signals from said sensors indicative of at least obstacle locations and generating signals output to said speakers to cause said speakers to emit sounds representative of a sensed obstacle and its location.

3. The safety device of claim 2, wherein said controller generates signals such that sounds are emitted from the speakers positionally corresponding to the obstacle location.

4. The safety device of claim 3, wherein said speakers form a part of a multi-channel audio system, said system further comprising an audio circuit disposed between said speakers and said controller to generate sound signals for said speakers.

5. The safety device of claim 4, wherein said multi-channel audio system further comprises a display driven by the audio circuit, said controller generating signals for displaying a visual indicator of the obstacle location on said display.

6. The safety device of claim 5, further comprising a plurality of A/D converters disposed between each said sensor and the controller.

7. The safety device of claim 6, wherein said sensors are mounted on front and rear parts of the vehicle and on left and rights sides of the vehicle.
